(19) United States
(12) Patent Application Publication
(10) Pub. No.: US 2017/0335858 A1
(43) Pub. Date: Nov. 23, 2017

(54) IMPELLER AND ROTARY MACHINE

(71) Applicant: MITSUBISHI HEAVY INDUSTRIES, LTD., Tokyo (JP)

(72) Inventors: Ryoji OKABE, Tokyo (JP); Isao TOMITA, Tokyo (JP); Atsushi MATSUO, Tokyo (JP); Yasunori WATANABE, Tokyo (JP)

(73) Assignee: MITSUBISHI HEAVY INDUSTRIES, LTD., Tokyo (JP)

(21) Appl. No.: 15/522,064

(22) PCT Filed: Oct. 8, 2015
(86) PCT No.: PCT/JP2015/078599

§ 371 Date: Apr. 26, 2017

(30) Foreign Application Priority Data
Nov. 25, 2014 (JP) 2014-237695

(51) Int. Cl. F04D 29/30; F04D 29/02; F02B 37/00

(52) U.S. Cl. CPC F04D 29/30; F04D 29/023; F02B 37/00

(57) ABSTRACT

This impeller is provided with: an impeller body having a disk-like shape and rotating about an axis together with a rotating shaft; and compressor blades (25) provided so as to protrude from the hub surface (31b) of the impeller body, the hub surface (31b) being formed on the front surface side of the impeller body, the compressor blades (25) each having a pair of side surfaces (26) which faces the circumferential direction of the rotating shaft and along which fluid flows. Each of the compressor blades (25) is formed in a tapered shape so that, within a range in which stress in the direction of the axis of at least the rotating shaft is maximum, the pair of side surfaces (26), when viewed in a cross-section perpendicular to the axis, approach each other as the pair of side surfaces (26) extends radially outward of the rotating shaft.

### TECHNICAL FIELD

The invention relates to an impeller provided in a rotary machine, and a rotary machine including an impeller.

Priority is claimed on Japanese Patent Application No. 2014-237695, filed Nov. 25, 2014, the content of which is incorporated herein by reference.

### BACKGROUND ART

While the global efforts of earth environment preservation proceed, intensification of regulations regarding exhaust gas or fuel efficiency in internal combustion engines, such as engines of automobiles is under way. The turbochargers are rotary machines that can enhance effects of fuel efficiency improvement and CO₂ reduction by sending compressed air into an engine to combust fuel compared to natural intake engines.

In the turbochargers, a turbine is rotationally driven with exhaust gas of an engine, thereby rotating an impeller of a centrifugal compressor (for example, PTL 1). The air compressed by the rotation of the impeller is raised in pressure by being reduced in speed by a diffuser, and is supplied to the engine through a scroll flow passage. In addition, as methods for driving the turbochargers, not only methods of being driven with exhaust gas but also, for example, methods using electric motors, methods using prime movers, and the like are known.

If the impeller rotates, due to a centrifugal force of the impeller, blades tend to be deformed toward a radial outer side, and a centrifugal stress is generated. In order to reduce the influence of such the centrifugal force, it is possible to make the thickness of each blade small.

### CITATION LIST

### Patent Literature

[PTL 1] Japanese Unexamined Utility Model Registration Application Publication No. H3-10040

### SUMMARY OF INVENTION

### Technical Problem

However, if the thickness of the blade is made small by considering the influence of the centrifugal force, a bending strength with respect to a pressure that a side surface (pressure surface) of the blade receives from a fluid may decrease, and a bending stress may increase.

The invention provides an impeller and a rotary machine capable of reducing a centrifugal stress and a bending stress in a well-balanced manner and improving strength.

### Solution to Problem

According to a first aspect of the invention, an impeller includes an impeller body forming a disk-like shape and rotating about an axis together with a rotating shaft; and a plurality of blades provided so as to protrude from a hub surface formed on a front surface side of the impeller body, the blades each having a pair of side surfaces that faces a circumferential direction of the rotating shaft and allows a fluid to flow therealong. Each of the blades is formed such that the pair of side surfaces in a cross-section perpendicular to the axis approaches each other as the pair of side surfaces becomes closer to a radial outer side of the rotating shaft, at least within a range where stress in a direction of the axis reaches a maximum.

According to such an impeller, the side surfaces of each of the blades approach each other as the side surfaces become closer to the radial outer side at least within the range where stress reaches a maximum. Thus, the thickness of each of the blades becomes small to the radial outer side. Therefore, the weight of the blade can be reduced at a position (a position on a tip side) on the radial outer side where the influence of a centrifugal force becomes great. For this reason, the centrifugal stress at a position (a position on the root side) on the radial inner side can be reduced. Additionally, since the thickness of the blade becomes large at a position on the root side compared to a position on the tip side, a bending strength with respect to a pressure received from a fluid is improved, and reduction of a bending stress at a position on the root side is also possible.

According to a second aspect of the invention, in each of the blades in the above first aspect, the pair of side surfaces in a cross-section orthogonal to the axis is formed so as to be curved in a concave shape in mutually approaching directions as the pair of side surfaces becomes closer to a radial outer side and approaches each other as the pair of side surfaces becomes closer to the radial outer side.

Since the side surfaces of each of the blades are curved in a concave shape in this way, the thickness of the blade can be made small rapidly at a position on the tip side of the blade. Additionally, the thickness of the blade can be made large rapidly at a position on the root side of the blade. For this reason, the centrifugal stress and the bending stress can be further reduced.

According a third aspect of the invention, each of the blades in the above first or second aspect may be formed such that the pair of side surfaces in a cross-section along the hub surface in a region close to the hub surface approaches each other as the pair of side surfaces becomes closer to the radial outer side in the direction of the axis, in a region on the radial outer side.

Since the side surfaces of the blade approach each other as the side surfaces become closer to the radial outer side in the direction of the axis in a region on the radial outer side in the blade in this way, the thickness of the blade becomes small from an inlet side for a fluid toward an outlet side. Therefore, since the gravity of the blade can be reduced at a position on the radial outer side where the influence of a centrifugal force becomes greater, a centrifugal stress generated in the blade can be further reduced.

According to a fourth aspect of the invention, the impeller body and the blades in any one of the above first to third aspects may be formed of a complex material consisting of a resin and reinforcing fibers.

The impeller formed of the complex material in this way has a small density compared to a metallic impeller, the ratio of the centrifugal stress to the bending stress becomes low, and the magnitude of the bending stress and the magnitude of the centrifugal stress are at an equal level. For this reason, if the thickness of the blade is made small such that the centrifugal stress is reduced, the bending stress increases even if the centrifugal stress can be reduced. On the contrary, if the thickness of the blade is made large such that the bending stress is reduced, the centrifugal stress increases even if the bending stress can be reduced. As a result, it is difficult to reduce the stress generated in the blade as a whole. In this reason, since the blade has a small thickness at a position on the tip side and the thickness becomes large at a position on the root side, the centrifugal stress and the bending stress can be reduced in a well-balanced manner, and it is possible to reduce the stress generated in the blade as a whole.

According to a fifth aspect of the invention, the reinforcing fibers may be disposed in the impeller body and the blades in the above fourth aspect so as to extend in a direction orthogonal to the hub surface.

The bending stress and the centrifugal stress of the blade are generated so as to run in the direction orthogonal to the hub surface.

For this reason, such stresses can be effectively reduced by disposing the reinforcing fibers in the direction in which these stresses are generated.

Here, according to the aspect of the invention, the side surfaces of the blade approach each other toward the radial outer side. Thus, the thickness becomes small toward a position on the radial outer side. For this reason, when the impeller of the complex material is molded, a pressure loss occurs toward the radial outer side in the direction of the axis. Therefore, the resin in the complex material does not easily flow in this direction. Therefore, during molding, the resin is made to flow in the direction orthogonal to the hub surface. As a result, the reinforcing fibers are naturally disposed so as to extend in the direction orthogonal to the hub surface. Therefore, since the impeller of the complex material is molded, a structure where stress is naturally reduced can be provided.

According to a sixth aspect of the invention, a rotary machine includes the impeller according to any one of the above first to fifth aspects; and a rotating shaft that is attached to the impeller and rotates together with the impeller.

According to such a rotary machine, the above impeller is provided. Therefore, the side surfaces of each of the blades approach each other as side surfaces become closer to the radial outer side at least in the range where stress reaches a maximum. Thus, the thickness of each of the blades becomes small to the radial outer side. Therefore, since the gravity of the blade can be reduced at a position on the radial outer side where the influence of a centrifugal force becomes greater, a centrifugal stress at a position on the root side of the blade can be further reduced. Additionally, since the thickness of the blade becomes large at a position on the root side compared to a position on the tip side, a bending strength with respect to a pressure received from a fluid is improved, and reduction of a bending stress at a position on the root side is also possible.

### Advantageous Effects of Invention

According to the above impeller and rotary machine, the blades of which the thickness becomes small as they become closer to the radial outer side of the rotating shaft. Thus, the centrifugal stress and the bending stress are reduced in a well-balanced manner, and an improvement in strength is possible.

### BRIEF DESCRIPTION OF DRAWINGS

FIG. 1 is a longitudinal sectional view illustrating a turbocharger related to a first embodiment of the invention.

FIG. 2 is a longitudinal sectional view illustrating a compressor impeller of the turbocharger related to the first embodiment of the invention.

FIG. 3 is a view illustrating a meridian plane shape of a blade of the compressor impeller of the turbocharger related to the first embodiment of the invention, a horizontal axis represents positions in a direction of an axis in the blade, and a vertical axis represents positions in a radial direction of a rotating shaft in the blade.

FIGS. 4A and 4B are longitudinal sectional views of a blade of the compressor impeller of the turbocharger related to the first embodiment of the invention. FIG. 4A illustrates an A-A section of FIG. 3. FIG. 4B illustrates a B-B section of FIG. 3.

FIG. 5 is a view illustrating a meridian plane shape of a blade of a compressor impeller of a turbocharger related to a second embodiment of the invention, a horizontal axis represents positions in the direction of the axis of the rotating shaft in the blade, and a vertical axis represents positions in the radial direction of the rotating shaft in the blade.

FIG. 6 is a view illustrating a cross-section along a hub surface of the blade of the compressor impeller of the turbocharger related to the second embodiment of the invention, and illustrating a C-C section of FIG. 5.

FIG. 7 is a view illustrating an example of a sectional shape along the hub surface of the blade of the compressor impeller of the turbocharger related to the second embodiment of the invention. A horizontal axis represents the distance from a fluid inlet (leading edge) of the blade on the meridian plane. A vertical axis represents ratios (blade thickness ratios: blade thickness ratio in a case where a maximum value of blade thickness is set to 1.0) of the thickness of the blade.

### DESCRIPTION OF EMBODIMENTS

### First Embodiment

Hereinafter, a turbocharger 1 (rotary machine) related to an embodiment of the invention will be described.

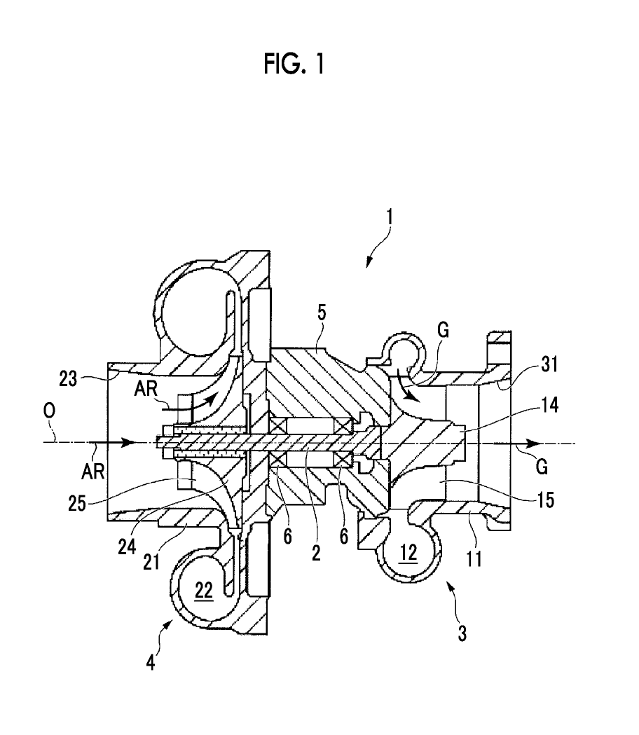

As illustrated in FIG. 1, the turbocharger 1 includes a rotating shaft 2, a turbine 3 and a compressor 4 that rotate together with the rotating shaft 2, and a housing coupling part 5 that couples the turbine 3 and the compressor 4 and supports the rotating shaft 2.

In the turbocharger 1, a turbine 3 is rotated with exhaust gas G from an engine (not illustrated), and air AR compressed by the compressor 4 is supplied to the engine with the rotation.

The rotating shaft 2 extends in a direction of an axis O. The rotating shaft 2 rotates about the axis O.

The turbine 3 is disposed on one side (the right side of FIG. 1) in the direction of the axis O.

The turbine 3 includes a turbine impeller 14 that has the rotating shaft 2 attached thereto and has a turbine blade 15, and a turbine housing 11 that covers the turbine impeller 14 from an outer peripheral side.

The rotating shaft 2 is fitted into the turbine impeller 14. The turbine impeller 14 is rotatable around the axis O together with the rotating shaft 2.

The turbine housing 11 covers the turbine impeller 14. A scroll passage 12, which extending from a leading edge part (an end part on a radial outer side) of the turbine blade 15 toward the radial outer side, is formed in an annular shape about the axis O at a position on the radial outer side, and allows the inside and outside of the turbine housing 11 to communicate with each other therethrough, is formed in the turbine housing 11. The turbine impeller 14 and the rotating shaft 2 are rotated by the exhaust gas G being introduced into the turbine impeller 14 from the scroll passage 12.

Additionally, a discharge port 13 opening to one side of the axis O is formed in the turbine housing 11. The exhaust gas G that has passed through the turbine blade 15 flows toward one side of the axis O, and is discharged from the discharge port 13 to the outside of the turbine housing 11.

The compressor 4 is disposed on the other side (the left side of FIG. 1) in the direction of the axis O.

The compressor 4 includes a compressor impeller 24 that has the rotating shaft 2 attached thereto and has a compressor blade 25, and a compressor housing 21 that covers the compressor impeller 24 from the outer peripheral side.

The rotating shaft 2 is fitted into the compressor impeller 24. The compressor impeller 24 is rotatable around the axis O together with the rotating shaft 2.

The compressor housing 21 covers the compressor impeller 24. A suction port 23 opening to the other side of the axis O is formed in the compressor housing 21. The air AR is introduced from the outside of the compressor housing 21 through the suction port 23 into the compressor impeller 24. By a rotative force from the turbine impeller 14 being transmitted to the compressor impeller 24 via the rotating shaft 2, the compressor impeller 24 rotates around the axis O and the air AR is compressed.

A compressor passage 22, which extend from a trailing edge part (a downstream end part of a flow of the air AR) of the compressor blade 25 toward the radial outer side, forms an annular shape about the axis O at a position on the radial outer side, and allows the inside and outside of the compressor housing 21 to communicate with each other therethrough, is formed in the compressor housing 21. The air AR compressed by the compressor impeller 24 is introduced to the compressor passage 22, and is discharged to the outside of the compressor housing 21.

The housing coupling part 5 is disposed between the compressor housing 21 and the turbine housing 11. The housing coupling part 5 couples the compressor housing 21 and the turbine housing 11. Moreover, the housing coupling part 5 covers the rotating shaft 2 from the outer peripheral side, and the housing coupling part 5 is provided with a bearing 6. The rotating shaft 2 is supported by the bearing 6 so as to be rotatable relative to the housing coupling part 5.

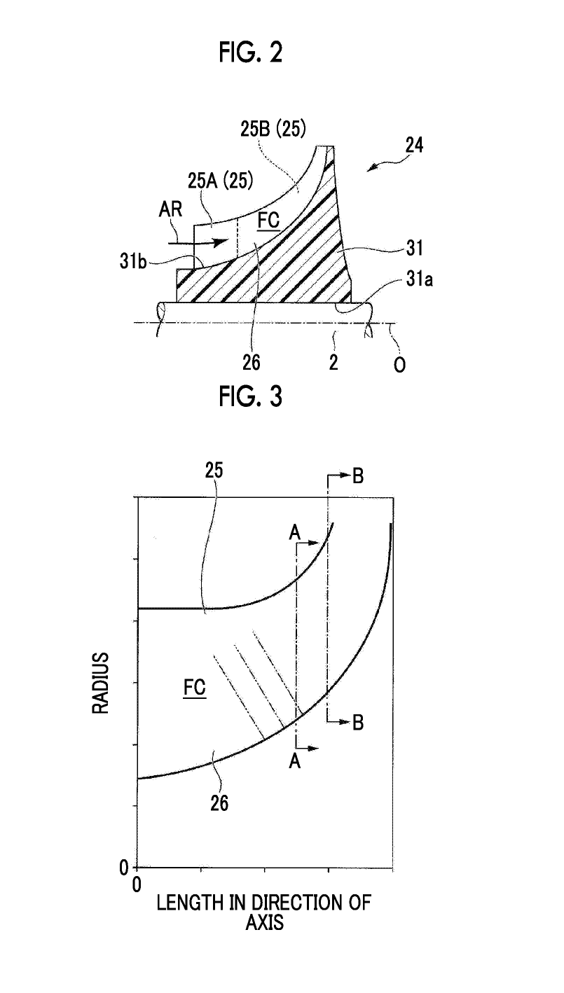

Next, the compressor impeller 24 will be described in detail with reference to FIG. 2.

The compressor impeller 24 includes a plurality of the compressor blades 25, and an impeller body 31 that supports the compressor blades 25 on the other side of the axis O that becomes a front surface side.

The impeller body 31 has a disk-like shape. The impeller body 31 is a so-called hub formed of a complex material consisting of a resin and reinforcing fibers.

Here, as resins used for the impeller body 31, polyether sulfone (PES), polyether imide (PEI), polyether ether ketone (PEEK), polyether ketone (PEK), polyether ketone ketone (PEKK) and poly ketone sulfide (PKS), polyaryl ether ketone (PAEK), aromatic polyamide (PA), polyamide imide (PAI), polyimide (PI), and the like are exemplified.

Additionally, as the reinforcing fibers used for the impeller body 31, carbon fibers, glass fibers, Whisker, and the like are exemplified.

A boss hole section 31a having the rotating shaft 2 inserted therethrough and fitted thereinto is formed in a region on a radial inner side in the impeller body 31. A surface formed on the front surface side of the impeller body 31 is a hub surface 31b formed so as to be inclined toward the radial outer side as it becomes closer to one side in the direction of the axis O.

The compressor blades 25 are formed of a complex material consisting of the same resin and reinforcing fibers as that the impeller body 31. The compressor blades 25 are provided so as to protrude from the hub surface 31b integrally with the impeller body 31.

As illustrated in FIGS. 2 to 4B, each of the compressor blades 25 has a pair of side surfaces 26 that faces a circumferential direction of the rotating shaft 2 and allows air (fluid) A to flow therealong. One of the pair of side surfaces 26 is a pressure surface that receives the pressure of air. The other of the pair of side surfaces 26 is a negative pressure surface.

The plurality of compressor blades 25 are provided apart from each other in the circumferential direction. A flow passage FC through which air AR flows is formed between side surfaces 26 that face each other in two compressor blades 25 adjacent to each other in the circumferential direction.

In the present embodiment, as the compressor blades 25, a long blade 25A extending from the other side (the front surface side of the impeller body 31) in the direction of the axis O in the hub surface 31b, and a short blade 25B extending from one side (back surface side of the impeller body 31) in the direction of the axis O more than the long blade 25A in the hub surface 31b are provided alternately in the circumferential direction.

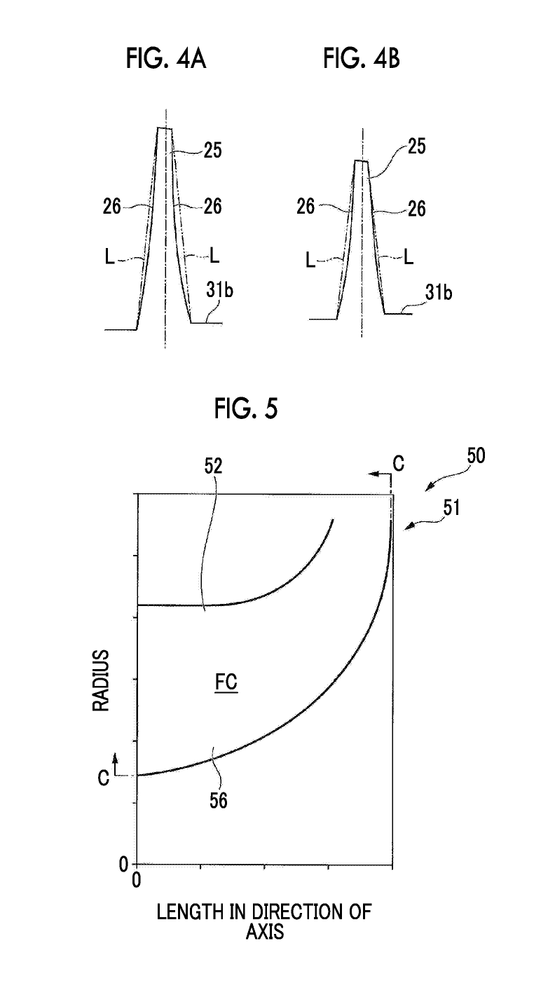

As illustrated in FIGS. 3 and 4, each compressor blade 25 is formed such that the pair of side surfaces 26 in a cross-section orthogonal to the axis O approaches each other as it becomes closer to the radial outer side of the rotating shaft 2. That is, the thickness of the compressor blade 25 becomes small toward the radial outer side.

In the compressor blade 25 of the present embodiment, the pair of side surfaces 26 is curved in a concave shape in mutually approaching directions as it becomes closer to the radial outer side.

In the compressor blade 25 of the present embodiment, the reinforcing fibers are disposed so as to extend in the direction orthogonal to the hub surface 31b. That is, the direction of the reinforcing fibers runs in a normal direction of the hub surface 31b (a direction of a two-dot chain line of FIG. 3).

According to the turbocharger 1 of the present embodiment described above, the thickness of the compressor blade 25 becomes small toward the radial outer side. Therefore, the weight of the compressor blade 25 can be reduced at a position (a position on a tip side) on the radial outer side where the influence of a centrifugal force becomes greater. For this reason, a centrifugal stress generated in the compressor blade 25 at the position (a position on a root side) on the radial inner side connected with the hub surface 31b side can be reduced. In addition, this centrifugal stress is a tensile stress generated such that the compressor blade 25 is pulled in the normal direction of the hub surface 31b.

In the compressor blade 25, the thickness thereof becomes large at a position on the root side compared to a position on the radial outer side that becomes the tip side. For this reason, a bending strength with respect to a pressure (a force acting on the side surface 26 that is the pressure surface) received from the air AR is improved, and reduction of a bending stress at a position on the root side is also possible.

Moreover, in the present embodiment, the pair of side surfaces 26 in the compressor blade 25 is curved in a concave shape. Thus, the thickness of the compressor blade 25 can be made small rapidly at a position on the tip side of the compressor blade 25. Additionally, the thickness can be made large rapidly at a position on the root side of the compressor blade 25. For this reason, the centrifugal stress and the bending stress can be further reduced.

Additionally, in the present embodiment, the compressor impeller 24 is formed of a complex material.

Here, the impeller of the complex material has a small density compared to a metallic impeller, the ratio of the centrifugal stress to the bending stress becomes low, and the magnitude of the bending stress and the magnitude of the centrifugal stress are at an equal level. For this reason, if the thickness of the blade is made small such that the centrifugal stress is reduced, the bending stress increases even if the centrifugal stress can be reduced. On the contrary, if the thickness of the blade is made large such that the bending stress is reduced, the centrifugal stress increases even if the bending stress can be reduced. As a result, it is difficult to reduce both the centrifugal stress and the bending stress to reduce the stress generated in the blade as a whole.

In this regard, the compressor blade 25 of the present embodiment has a small thickness at a position on the tip side and has a large thickness at a position on the root side. For this reason, the centrifugal stress and the bending stress can be reduced in a well-balanced manner, and it is possible to reduce the stress generated in the compressor blade 25 as a whole.

In the compressor blade 25, the reinforcing fibers are disposed so as to extend in the direction orthogonal to the hub surface 31b. Here, the bending stress and the centrifugal stress of the compressor blade 25 are generated so as to run in the direction orthogonal to the hub surface 31b, that is, the normal direction of the hub surface 31b. In the present embodiment, such stresses can be effectively reduced by disposing the reinforcing fibers in the direction in which these stresses are generated.

Here, in the present embodiment, the pair of side surfaces 26 of each compressor blade 25 approaches each other toward the radial outer side. Thus, the thickness becomes small toward a position on the radial outer side in a cross-section orthogonal to the axis O. For this reason, when the compressor impeller 24 of the complex material is molded, a pressure loss occurs toward the radial outer side in the direction of the axis O.

As a result, the resin in the complex material does not easily flow in this direction. Therefore, during molding, the resin is made to flow in the direction orthogonal to the hub surface 31b, the reinforcing fibers are naturally disposed so as to extend in the direction orthogonal to the hub surface 31b, and the compressor impeller 24 of the complex material is molded. Thus, it is possible to provide a structure where stress is naturally reduced during molding.

Here, the compressor blade 25 of the present embodiment has only to be formed into a tapered shape such that the side surfaces 26 approach each other like as it becomes closer to the radial outer side as described above, in a range where at least the stress in the direction of the axis O of the rotating shaft 2 acquired in advance reaches a maximum. That is, the compressor blade 25 may not have the tapered shape in this way in the whole region in the direction of the axis O.

### Second Embodiment

Next, a second embodiment of the invention will be described with reference to FIGS. 5 to 7.

The same constituent elements as those of the first embodiment will be designated by the same reference signs, and the detailed description thereof will be omitted.

The turbocharger 50 of the present embodiment is different from the first embodiment in the shape of compressor blades 52 in a compressor impeller 51.

Namely, each compressor blade 52 of the present embodiment, similar to each compressor blade 25 of the first embodiment, are formed such that a shape of a cross-section (a cross-section in the radial direction) orthogonal to the axis O is formed into a tapered shape, and additionally, a pair of side surfaces 56 in a cross-section along the hub surface 31b approaches each other as it becomes closer to the radial outer side in the direction of the axis O in a region (a region including a position connected to the hub surface 31b) close to the hub surface 31b a region on the radial outer side.

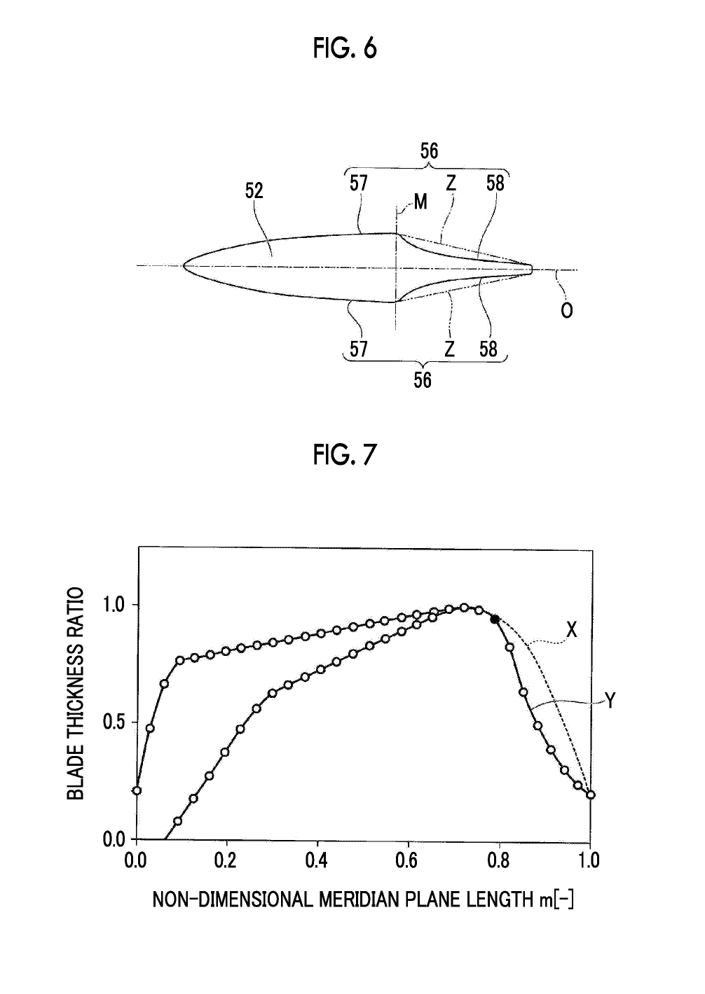

In more detail, as illustrated in FIG. 6, in the present embodiment, each of the pair of side surfaces 56 has a leading edge side surface 57 formed in a region closer to the other side (the front surface side of the impeller body 31) in the direction of the axis O than a halfway position M in the direction of the axis O from a leading edge end of the compressor blade 52 along a meridian plane of the compressor blade 52, and a trailing edge side surface 58 formed in a region up to a trailing edge end of the compressor blade 52, continuously with the leading edge side surface 57.

The leading edge side surfaces 57 in the pair of side surfaces 56 are formed being curved in a convex shape so as to be spaced apart from each other in the circumferential direction.

The trailing edge side surfaces 58 in the pair of side surfaces 56 are continuous with the leading edge side surfaces 57, respectively, and are curved and formed in a concave shape such that the compressor blade 52 has a tapered shape along the meridian plane by approaching each other in the circumferential direction.

According to the turbocharger 50 of the present embodiment described above, the trailing edge side surfaces 58 are formed in the regions on the radial outer side in the compressor blade 52. Thus, the side surfaces 56 approach each other as they become closer to the radial outer side along the meridian plane of the compressor impeller 51 in the direction of the axis O. For this reason, the thickness of the compressor blade 52 becomes small toward the radial outer side, and the gravity of the compressor blade 52 can be reduced at a position on the radial outer side where the influence of a centrifugal force becomes larger. Therefore, the centrifugal stress at a position on the root side of the compressor blade 52 can be further reduced.

Moreover, in the present embodiment, the trailing edge side surfaces 58 are curved in a concave shape. Thus, the thickness of the compressor blade 52 becomes small rapidly.

Namely, compared to a case where the trailing edge side surfaces 58 in the pair of side surfaces 56, similar to the leading edge side surfaces 57, are curved and formed in a convex shape so as to be spaced apart from each other in the circumferential direction as illustrated by a dashed line X of FIG. 7, the thickness of the compressor blade 52 becomes small rapidly from the above halfway position as illustrated by a solid line Y of FIG. 7, in the case of the present embodiment.

Therefore, the centrifugal stress and the bending stress generated in the compressor blade 52 can be further reduced.

Here, the pair of trailing edge side surfaces 58 in each compressor blade 52 of the present embodiment are not limited to a case where the trailing edge side surfaces are curved in a concave shape, and may be provided so as to approach each other as it extends linearly and becomes closer to the radial outer side (refer to a two-dot chain line Z of FIG. 6). Namely, the compressor blade 52 has only to have at least a tapered shape toward the trailing edge side.

Although the embodiments of the invention have been described above in detail, some design changes can also be made without departing from the technical idea of the invention.

For example, the compressor impellers 24 and 51 are not limited to a case where the compressor impellers are made of the complex material, and may be made of a metal.

Additionally, in a case where the compressor blades 25 and 52 are formed of the complex material, the direction in which the reinforcing fibers extend is not limited to a direction orthogonal to the hub surface 31b.

Additionally, the pair of side surfaces 26 in each of the compressor blades 25 and 52 are not limited to a case where the side surfaces are curved in a concave shape, and may be provided so as to approach each other as it extends linearly and becomes closer to the radial outer side (refer to a two-dot chain line L of FIG. 4).

Additionally, in the above-described embodiments, as the rotary machine, the turbocharger has been described as an example. However, the invention may be used for other centrifugal compressors and the like.

### INDUSTRIAL APPLICABILITY

According to the above impeller and rotary machine, the blades of which the thickness becomes small as they become closer to the radial outer side of the rotating shaft. Thus, the centrifugal stress and the bending stress are reduced in a well-balanced manner, and an improvement in strength is possible.

### REFERENCE SIGNS LIST

1: TURBOCHARGER (ROTARY MACHINE)
2: ROTATING SHAFT
3: TURBINE
4: COMPRESSOR
5: HOUSING COUPLING PART
6: BEARING
11: TURBINE HOUSING
12: SCROLL PASSAGE
13: DISCHARGE PORT
14: TURBINE IMPELLER
15: TURBINE BLADE
21: COMPRESSOR HOUSING
22: COMPRESSOR PASSAGE
23: SUCTION PORT
24: COMPRESSOR IMPELLER
25: COMPRESSOR BLADE
25A: LONG BLADE
25B: SHORT BLADE
26: SIDE SURFACE
31: IMPELLER BODY
31a: BOSS HOLE SECTION
31b: HUB SURFACE
G: EXHAUST GAS
AR: AIR
O: AXIS
FC: FLOW PASSAGE
50: TURBOCHARGER (ROTARY MACHINE)
51: COMPRESSOR IMPELLER
52: COMPRESSOR BLADE
56: SIDE SURFACE
57: LEADING EDGE SIDE SURFACE
58: TRAILING EDGE SIDE SURFACE

1. An impeller comprising:
an impeller body forming a disk-like shape and rotating about an axis together with a rotating shaft; and
a plurality of blades provided so as to protrude from a hub surface formed on a front surface side of the impeller body, the blades each having a pair of side surfaces that faces a circumferential direction of the rotating shaft and allows a fluid to flow therealong,
wherein each of the blades is formed such that the pair of side surfaces in a cross-section perpendicular to the axis approaches each other as the pair of side surfaces becomes closer to a radial outer side of the rotating shaft, at least within a range where stress in a direction of the axis of the rotating shaft reaches a maximum.

2. The impeller according to claim 1,
wherein the pair of side surfaces in each of the blades is formed so as to be curved in a concave shape in mutually approaching directions as the pair of side surfaces becomes closer to a radial outer side and approaches each other as the pair of side surfaces becomes closer to the radial outer side.

3. The impeller according to claim 1,
wherein each of the blades is formed such that the pair of side surfaces in a cross-section along the hub surface in a region close to the hub surface approaches each other as the pair of side surfaces becomes closer to the radial outer side in the direction of the axis, in a region on the radial outer side.

4. The impeller according to claim 1,
wherein the impeller body and the blades are formed of a complex material consisting of a resin and reinforcing fibers.

5. The impeller according to claim 4,
wherein the reinforcing fibers are disposed in the impeller body and the blades so as to extend in a direction orthogonal to the hub surface.

6. A rotary machine comprising:
the impeller according to claim 1; and
a rotating shaft that is attached to the impeller and rotates together with the impeller.

7. The impeller according to claim 2,
wherein each of the blades is formed such that the pair of side surfaces in a cross-section along the hub surface in a region close to the hub surface approaches each other as the pair of side surfaces becomes closer to the radial outer side in the direction of the axis, in a region on the radial outer side.

8. The impeller according to claim 2,
wherein the impeller body and the blades are formed of a complex material consisting of a resin and reinforcing fibers.

9. The impeller according to claim 3,
wherein the impeller body and the blades are formed of a complex material consisting of a resin and reinforcing fibers.

10. A rotary machine comprising:
the impeller according to claim 2; and
a rotating shaft that is attached to the impeller and rotates together with the impeller.

11. A rotary machine comprising:
the impeller according to claim 3; and
a rotating shaft that is attached to the impeller and rotates together with the impeller.

12. A rotary machine comprising:
the impeller according to claim 4; and
a rotating shaft that is attached to the impeller and rotates together with the impeller.

13. A rotary machine comprising:
the impeller according to claim 5; and
a rotating shaft that is attached to the impeller and rotates together with the impeller.
